(19) United States
(12) Patent Application Publication
(10) Pub. No.: US 2003/0121404 A1
(43) Pub. Date: Jul. 3, 2003

(54) Attack aircraft

(76) Inventor: James Michael O'Dwyer, Queensland (AU)

Correspondence Address: FINNEGAN, HENDERSON, FARABOW, GARRETT & DUNNER, LLP, 1300 I STREET, NW, WASHINGTON, DC, 20005, US

(21) Appl. No.: 10/275,549

(22) PCT Filed: May 4, 2001
(86) PCT No.: PCT/AU01/00511

(30) Foreign Application Priority Data
May 8, 2000 (AU) PQ 7379

(51) Int. Cl. F41F 5/00; B64D 1/04

(52) U.S. Cl. 89/1.41

(57) ABSTRACT

Aircraft (10) carries at least two clusters of barrel assemblies. At least one cluster is oriented normal to the longitudinal axis of aircraft (10) and at least one other cluster is oriented parallel to the longitudinal axis of aircraft (10). Each cluster comprises a plurality of barrel assemblies, with each barrel having a plurality of axially disposed projectiles therein. Each projectile is associated with a discrete, sequentially activated propellant charge for propelling it through the muzzle of the barrel. Various methods of deploying a multiplicity of projectiles onto a target from aircraft (10) are also described and claimed. The projectiles deployment might occur at any time whils aircraft (10) is approaching the target, overflying the target, or departing from the target. The projectiles may include smoke canisters, high explosive canisters, flares, electronic and thermal countermeasures, mines, grenades or cameras.

### BACKGROUND OF THE INVENTION

1. Field of the Invention

The present invention relates to a method of deploying a multiplicity of projectiles on a target such as when conducting a bombing raid and an attack aircraft therefor.

2. Discussion of the Background Art

Bombing raids are one of the most commonly employed forms of offence against a hostile target. However the effectiveness of such raids is generally limited by the short duration available for dropping or firing bombs from a bomber at a target. While slowing the bomber may increase this duration, this tactic would place the bomber at a greater risk of attack from either ground or air. Whilst the risk to the crew of the bomber may be totally eliminated by utilising an unmanned aircraft, the degree of sophistication required for effective operation of such an aircraft would cause such raids to be high cost operations. Furthermore the ability of unmanned aircraft to adapt to changes in operational parameters is generally lesser than that of manned aircraft. The loss of such unmanned aircraft to attack from ground fire would be significant.

Increasing the rate of fire or discharge of bombs capability of the aircraft may also increase the effectiveness of such raids. However there is a limit to which the rate of fire can be increased as the stability of the aircraft would upset by reaction to the rapid firing of projectiles therefrom.

### SUMMARY OF THE INVENTION

We have now found that by rapidly deploying a multiplicity of projectiles from clusters of barrel assemblies mounted on an aircraft enables the number of projectile fired at the target to be maximised and the risk to the aircraft to attack to be minimised.

Accordingly in a first embodiment we provide a method of deploying a multiplicity of projectiles on a target from an aircraft comprising the steps of:

flying toward the target while firing on the target from a first cluster of barrel assemblies wherein the first cluster of barrel assemblies comprises a plurality of barrel assemblies having a plurality of projectiles axially disposed therein, which projectiles are associated with discrete, sequentially activated propellant charges for propelling the projectiles through the muzzle of the barrel; and

flying over the target while firing on the target from a second cluster of barrel assemblies wherein the second cluster of barrel assemblies comprises a plurality of barrel assemblies having a plurality of projectiles axially disposed therein, which projectiles are associated with discrete, sequentially activated propellant charges for propelling the projectiles through the muzzle of the barrel.

In a second embodiment the present invention provides a method of deploying a multiplicity of projectiles on a target from an aircraft comprising the steps of:

flying over the target while firing on the target from a second cluster of barrel assemblies wherein the second cluster of barrel assemblies comprises a plurality of barrel assemblies having a plurality of projectiles axially disposed therein, which projectiles are associated with discrete, sequentially activated propellant charges for propelling the projectiles through the muzzle of the barrel; and

flying away from the target while firing on the target from a third cluster of barrel assemblies wherein the third cluster of barrel assemblies comprises a plurality of barrel assemblies. Having a plurality of projectiles axially disposed therein, which projectiles are associated with discrete, sequentially activated propellant charges for propelling the projectiles through the muzzle of the barrel.

In a third embodiment of the present invention there is provided a method of deploying a multiplicity of projectiles on a target from an aircraft comprising the steps of:

flying toward the target while firing on the target from a first cluster of barrel assemblies wherein the first cluster of barrel assemblies comprises a plurality of barrel assemblies having a plurality of projectiles axially disposed therein, which projectiles are associated with discrete, sequentially activated propellant charges for propelling the projectiles through the muzzle of the barrel;

flying away from the target while firing on the target from a third cluster of barrel assemblies wherein the third cluster of barrel assemblies comprises a plurality of barrel assemblies having a plurality of projectiles axially disposed therein, which projectiles are associated with discrete, sequentially activated propellant charges for propelling the projectiles through the muzzle of the barrel.

In a fourth embodiment of the present invention there is provided a method of deploying a multiplicity of projectiles on a target from an aircraft comprising the steps of:

flying toward the target while firing on the target from a first cluster of barrel assemblies wherein the first cluster of barrel assemblies comprises a plurality of barrel assemblies having a plurality of projectiles axially disposed therein, which projectiles are associated with discrete, sequentially activated propellant charges for propelling the projectiles through the muzzle of the barrel;

flying over the target while firing on the target from a second cluster of barrel assemblies wherein the second cluster of barrel assemblies comprises a plurality of barrel assemblies having a plurality of projectiles axially disposed therein, which projectiles are associated with discrete, sequentially activated propellant charges for propelling the projectiles through the muzzle of the barrel; and

flying away from the target while firing on the target from a third cluster of barrel assemblies wherein the third cluster of barrel assemblies comprises a plurality of barrel assemblies having a plurality of projectiles axially disposed therein, which projectiles are associated with discrete, sequentially activated propellant charges for propelling the projectiles through the muzzle of the barrel.

In a further aspect of the present invention there is provided an aircraft comprising at least two clusters of barrel assemblies, wherein at least one cluster in oriented substantially normal to the axis of the aircraft and at least one other cluster is oriented substantially parallel to the axis of the aircraft and wherein each cluster comprising a plurality of barrel assemblies having a plurality of projectiles axially disposed therein, which projectiles are associated with discrete, sequentially activated propellant charges for propelling the projectiles through the muzzle of the barrel.

This invention may utilise barrel assemblies capable of firing a controlled rapid fire sequence of mortar like projectiles and being of the general type described and/or illustrated in our earlier International Patent Applications such as PCT/AU94/00124, PCT/AU00/00296 and PCT/AU00/00297. In at least some of these earlier applications, including the earliest filed International Application No PCT/AU94/00124 there are described arrangements for grouping barrels each containing a plurality of projectiles so that a large number of projectiles can be fired in rapid-fire succession. In such arrangements barrels may be formed from a cylindrical shell having a plurality of projectiles axially disposed within the shell for operative sealing engagement with the bore of the shell and discrete propellant charges for propelling respective projectiles.

Suitably the barrel assemblies may be of the low-pressure type which fire grenade-like projectiles although high muzzle pressure barrel assemblies may be used. Respective barrel assemblies may be loaded with different projectiles and the barrel assemblies may have different size bores for accommodating different size projectiles. This will enable greater flexibility in projectile selection in attacking a selected target.

Suitably each projectile includes a trailing collar captively mounted to the projectile body and when stored in the barrel, extends rearwardly to wedge against the nose portion of a trailing projectile body. Suitably the wedging action is provided by a shallow wedge whereby, in use, the trailing end of the collar is expanded into operative sealing engagement with the barrel.

The trailing collar may be mounted for limited axial movement relative to the projectile body and the leading end of the collar formed with an annular sealing face engageable with a complementary face formed on the projectile body whereby rearward movement of the projectile body resulting from the reaction of propellant gases thereon forces the its complementary face into sealing engagement with the annular sealing face at the leading end of the collar.

The complementary face and the annular sealing face may extend substantially radially and be formed with complementary sealing features thereon. However it is preferred that these faces are complementary part-conical sealing faces which wedge into tight sealing engagement with one another. The leading end part may also be expandable into operative sealing engagement with the barrel. Suitably however the wedging between the part-conical faces are relatively steep faces whereby the leading end of the collar is not expanded into operative sealing engagement with the barrel by the wedging action.

Preferably each projectile is associated with a high pressure propellant chamber which exhausts to respective low pressure propulsion chambers formed between the adjacent projectiles for efficient low muzzle velocity operation. The high pressure propellant chambers may be formed integrally with the projectile body or the trailing collar or be provided at the exterior of the barrel to communicate therewith through ports provided through the barrel wall.

The first, second and third clusters of projectiles may advantageously be combined with conventional projectiles. In the first and second embodiments of the present invention it may be advantageous to replace the second cluster of projectiles with conventional projectiles. In the third embodiment of the present invention a second cluster of conventional projectiles may be employed for firing on the target as the aircraft flies over the target.

By utilising this method, the action of firing from the first cluster of barrel assemblies may advantageously slow the descent of the aircraft. This effect may be used to assist a rapid change in attitude or turnaround between diving and climbing. Furthermore, firing rearwardly from the third cluster of barrel assemblies during climb will assist in accelerating the aircraft away from the target zone.

Advantageously the execution of the attack manoeuvre may be such that the aircraft dives at a higher speed than would be otherwise practical. In order to pull out of the dive and climb away. The aircraft may fire from the first cluster of barrel assemblies as the aircraft approaches the target so as to achieve the secondary effect of slowing the descent of the aircraft sufficiently to execute the change of attitude or change of direction to climbing manoeuvre and then firing from the third pod of barrel assemblies as the aircraft departs the target so as to achieve the secondary effect of accelerating the aircraft away from he target.

This form of attack will minimise the time during which the aircraft is exposed by it's maximum profile to attack from ground fire. It also minimises the time during which the aircraft is closest the target. Advantageously this form of attack increases the time during which the target may be under attack from an aircraft. Furthermore as the target is attacked from at least two directions and for a longer period, the attack should be more successful.

In addition during the dive toward and climb from the target the aircraft provides only a relatively small front profile as a target for ground attack and thus minimises the danger to the aircraft from ground attack. The sudden change of direction of the aircraft adjacent the target may also have the effect of making the aircraft difficult to follow for target homing missiles and the like approaching as the aircraft approaches the target.

The aircraft may also be provided with a second pod of barrel assemblies of the type described and capable of firing downwardly from the aircraft and which may be fired during the transition between diving and climbing. The third pod may be positioned on the aircraft such that the reaction from firing produces a positive pitching moment to assist transition of the aircraft to its climb attitude.

The first cluster of barrel assemblies alone or all the clusters may be mounted for pivotal movement about an axis athwart the aircraft so that beneficial effects may be achieved such as pivoting the first cluster or pod during transition from dive to climb so as to maintain the aim toward the target which may be a point or area target. Firing from the first cluster or pod while sweeping the barrels may also be utilised to affect a nose up attitude of the aircraft during its change in attitude from the dive. The barrels in each cluster or pod may also be controlled for splay so that the target area may be broadened for broad area engagement during the bombing raid.

The barrel assemblies may be armed with non-explosive or explosive rounds or a combination of same as desired. The pods of barrel assemblies may include barrel assemblies that may be selectively used for defence against hostile aircraft or for attacking the target. The projectiles may in addition include smoke canisters, high explosive canisters, flares, electronic and thermal counter measures, mines or cameras.

The aircraft may be a manned aircraft or an unmanned aircraft.

The various aircraft configurations as described above constitute further aspects of this invention.

### BRIEF DETAILS OF THE DRAWINGS

In order that this invention may be more readily understood and put into practical effect, reference will now be made to the accompanying drawings which illustrate a typical embodiment of the invention and wherein:

FIG. 1 is a diagrammatic side view illustrating a method of attack utilising an unmanned aircraft; and

FIG. 2 is an underside view of the aircraft illustrated in FIG. 1.

### DESCRIPTION OF EMBODIMENTS OF THE INVENTION

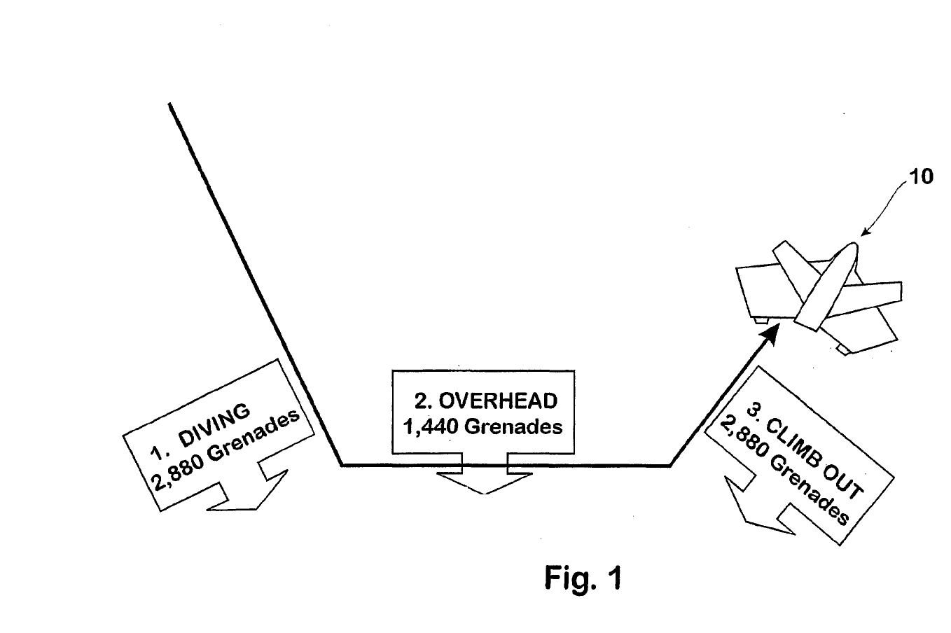

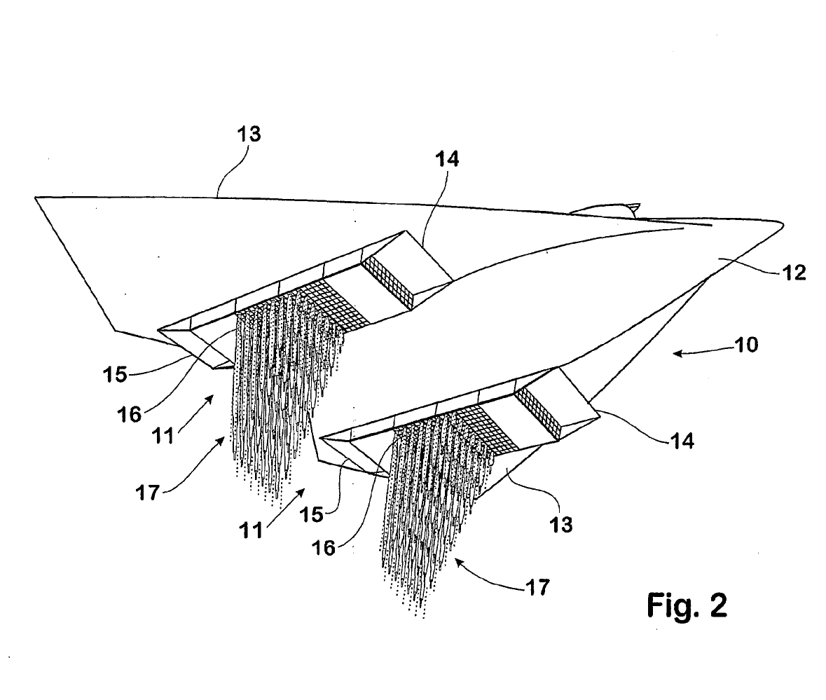

The aircraft 10 illustrated in FIGS. 1 and 2 is an unmanned delta wing type aircraft provided with an array of barrel assemblies 11 at each side of the fuselage 12 and beneath the wings 13. Each array 11 contains a first pod of barrel assemblies 14 which face forwardly, a second pod of barrel assemblies 15 which face rearwardly, and a third pod of barrel assemblies 16 which face downwardly and which are shown in FIG. 2 sequentially discharging rounds 17.

In this embodiment the rounds 17 are grenade type rounds which are housed forty to a barrel in thirty-six relatively long barrel assemblies in each of the first and second pods and five to a barrel in one hundred and forty-four relatively short barrels in each of the third pods 16.

In use, the aircraft 10 commences an attack manoeuvre from a high altitude by diving toward the target. Initially the aircraft locks onto the target and arms the grenades or their time of firing to achieve explosion thereof at the appropriate time.

The grenades from the first pods 14 are then fired and the aircraft is immediately pitched to a climbing attitude. At the end of the dive the velocity of the aircraft will be slowed by firing the first pods so that the pitching manoeuvre is performed at a lower speed than the dive speed of the aircraft before firing the pods 14. The third set of projectiles is fired downward directly onto the target while the aircraft is substantially horizontal and preferably so as to impart a positive pitching moment to the aircraft 10. When the aircraft 10 is oriented to its climb path with the rearwardly facing pods 15 aligned with the target these pods 15 are fired. This will give a substantial boost to the forward speed of the aircraft and assist it to depart quickly from the target.

Upon completion of an attack manoeuvre the aircraft 10 will have delivered 2,880 grenades onto the target during the last part of its dive during which it presented a relatively small target for ground fire. It will have then delivered a further 1,440 grenades onto the target during transition to the climb attitude and a further 2,880 grenades immediately upon commencement of its climb.

The rate of fire of the barrel assemblies in the pods 14, 15 and 16 is variable and may be preset or remotely controlled to achieve the desired destructive or deterrent result

By way of example an aircraft provided with two external arrays of pods may have 12 pods of barrel assemblies each containing 100 barrels each loaded with six grenades to provide a payload of 7,200 grenades each of which would weigh in the order of 0.25 kg each. Suitably for weight saving purposes the barrels would be formed of composite plastics material weighing about 0.3 kg each which together with the frame and support should weigh altogether about 2,200 kg and each pod would have a frontal area of about 0.6 m square×0.9 m long.

It will of course be realised that while the foregoing description has been given by way of illustrative example of this invention, all such and other modifications and variations thereto as would be apparent to persons skilled in the art are deemed to fall within the broad scope and ambit of this invention as is herein set forth in the following claims.

1. A method of deploying a multiplicity of projectiles on a target from an aircraft comprising the steps of:
flying toward the target while firing on the target from a first cluster of barrel assemblies wherein the first cluster of barrel assemblies comprises a plurality of barrel assemblies having a plurality of projectiles axially disposed therein, which projectiles are associated with discrete, sequentially activated propellant charges for propelling the projectiles through the muzzle of the barrel; and
flying over the target while firing on the target from a second cluster of barrel assemblies wherein the second cluster of barrel assemblies comprises a plurality of barrel assemblies having a plurality of projectiles axially disposed therein, which projectiles are associated with discrete, sequentially activated propellant charges for propelling the projectiles through the muzzle of the barrel.

2. A method according to claim 1 wherein each projectile includes a trailing collar captively mounted to the projectile body and when stored in the barrel, extends rearwardly to wedge against the nose portion of a trailing projectile body.

3. A method according to claim 2 wherein wedging action is provided by a shallow wedge whereby, in use, the trailing end of the collar is expanded into operative sealing engagement with the barrel.

4. A method according to any one of claims 1 to 3 wherein the trailing collar is mounted for limited axial movement relative to the projectile body and the leading end of the collar formed with an annular sealing face engageable with a complementary face formed on the projectile body whereby rearward movement of the projectile body resulting from the reaction of propellant gases thereon forces the its complementary face into sealing engagement with the annular sealing face at the leading end of the collar.

5. A method according to claim 4 wherein the complementary face and the annular sealing face may extend substantially radially and be formed with complementary sealing features thereon and wherein these faces are complementary part-conical sealing faces which wedge into tight sealing engagement with one another.

6. A method according to any one of claims 1 to 5 wherein each projectile is associated with a high pressure propellant chamber which exhausts to respective low pressure propulsion chambers formed between the adjacent projectiles for efficient low muzzle velocity operation and said high pressure propellant chambers may be formed integrally with the projectile body or the trailing collar or be provided at the exterior of the barrel to communicate therewith through ports provided through the barrel wall.

7. A method according to any one of claims 1 to 6 wherein the first and second clusters of barrel assemblies may be combined with conventional projectiles.

8. A method according to any one of claims 1 to 7 wherein the first and/or second clusters are mounted for pivotal movement about an axis athwart the aircraft to facilitate pivoting the clusters so as to maintain aim toward the target.

9. A method of deploying a multiplicity of projectiles on a target from an aircraft comprising the steps of:
flying over the target while firing on the target from a second cluster of barrel assemblies wherein the second cluster of barrel assemblies comprises a plurality of barrel assemblies having a plurality of projectiles axially disposed therein, which projectiles are associated with discrete, sequentially activated propellant charges for propelling the projectiles through the muzzle of the barrel; and
flying away from the target while firing on the target from a third cluster of barrel assemblies wherein the third cluster of barrel assemblies comprises a plurality of barrel assemblies having a plurality of projectiles axially disposed therein, which projectiles are associated with discrete, sequentially activated propellant charges for propelling the projectiles through the muzzle of the barrel.

10. A method according to claim 9 wherein each projectile includes a trailing collar captively mounted to the projectile body and when stored in the barrel, extends rearwardly to wedge against the nose portion of a trailing projectile body.

11. A method according to claim 10 wherein wedging action is provided by a shallow wedge whereby, in use, the trailing end of the collar is expanded into operative sealing engagement with the barrel.

12. A method according to any one of claims 9 to 11 wherein the trailing collar is mounted for limited axial movement relative to the projectile body and the leading end of the collar formed with an annular sealing face engageable with a complementary face formed on the projectile body whereby rearward movement of the projectile body resulting from the reaction of propellant gases thereon forces the its complementary face into sealing engagement with the annular sealing face at the leading end of the collar.

13. A method according to claim 12 wherein the complementary face and the annular sealing face extend substantially radially and are formed with complementary sealing features thereon and wherein these faces are complementary part-conical sealing faces which wedge into tight sealing engagement with one another.

14. A method according to any one of claims 9 to 13 wherein each projectile is associated with a high pressure propellant chamber which exhausts to respective low pressure propulsion chambers formed between the adjacent projectiles for efficient low muzzle velocity operation and said high pressure propellant chambers are formed integrally with the projectile body or the trailing collar or are provided at the exterior of the barrel to communicate therewith through ports provided through the barrel wall.

15. A method according to any one of claims 9 to 14 wherein the second and third clusters of barrel assemblies are combined with conventional projectiles.

16. A method according to any one of claims 9 to 15 wherein the second and/or third clusters are mounted for pivotal movement about an axis athwart the aircraft to facilitate pivoting the clusters so as to maintain aim toward the target.

17. A method of deploying a multiplicity of projectiles on a target from an aircraft comprising the steps of:
flying toward the target while firing on the target from a first cluster of barrel assemblies wherein the first cluster of barrel assemblies comprises a plurality of barrel assemblies having a plurality of projectiles axially disposed therein, which projectiles are associated with discrete, sequentially activated propellant charges for propelling the projectiles through the muzzle of the barrel;
flying away from the target while firing on the target from a third cluster of barrel assemblies wherein the third cluster of barrel assemblies comprises a plurality of barrel assemblies having a plurality of projectiles axially disposed therein, which projectiles are associated with discrete, sequentially activated propellant charges for propelling the projectiles through the muzzle of the barrel.

18. A method according to claim 17 wherein each projectile includes a trailing collar captively mounted to the projectile body and when stored in the barrel, extends rearwardly to wedge against the nose portion of a trailing projectile body.

19. A method according to claim 18 wherein wedging action is provided by a shallow wedge whereby, in use, the trailing end of the collar is expanded into operative sealing engagement with the barrel.

20. A method according to any one of claims 17 to 19 wherein the trailing collar is mounted for limited axial movement relative to the projectile body and the leading end of the collar formed with an annular sealing face engageable with a complementary face formed on the projectile body whereby rearward movement of the projectile body resulting from the reaction of propellant gases thereon forces the its complementary face into sealing engagement with the annular sealing face at the leading end of the collar.

21. A method according to claim 20 wherein the complementary face and the annular sealing face extend substantially radially and are formed with complementary sealing features thereon and wherein these faces are complementary part-conical sealing faces which wedge into tight sealing engagement with one another.

22. A method according to any one of claims 17 to 21 wherein each projectile is associated with a high pressure propellant chamber which exhausts to respective low pressure propulsion chambers formed between the adjacent projectiles for efficient low muzzle velocity operation and said high pressure propellant chambers are formed integrally with the projectile body or the trailing collar or are provided at the exterior of the barrel to communicate therewith through ports provided through the barrel wall.

23. A method according to any one of claims 1 to 22 wherein the first and third clusters of barrel assemblies are combined with conventional projectiles.

24. A method according to any one of claims 17 to 23 wherein the first and/or third clusters are mounted for pivotal movement about an axis athwart the aircraft to facilitate pivoting the clusters so as to maintain aim toward the target.

25. A method of deploying a multiplicity of projectiles on a target from an aircraft comprising the steps of:
flying toward the target while firing on the target from a first cluster of barrel assemblies wherein the first cluster of barrel assemblies comprises a plurality of barrel assemblies having a plurality of projectiles axially disposed therein, which projectiles are associated with discrete, sequentially activated propellant charges for propelling the projectiles through the muzzle of the barrel;
flying over the target while firing on the target from a second cluster of barrel assemblies wherein the second cluster of barrel assemblies comprises a plurality of barrel assemblies having a plurality of projectiles axially disposed therein, which projectiles are associated with discrete, sequentially activated propellant charges for propelling the projectiles through the muzzle of the barrel; and
flying away from the target while firing on the target from a third cluster of barrel assemblies wherein the third cluster of barrel assemblies comprises a plurality of barrel assemblies having a plurality of projectiles axially disposed therein, which projectiles are associated with discrete, sequentially activated propellant charges for propelling the projectiles through the muzzle of the barrel.

26. A method according to claim 25 wherein each projectile includes a trailing collar captively mounted to the projectile body and when stored in the barrel, extends rearwardly to wedge against the nose portion of a trailing projectile body.

27. A method according to claim 26 wherein wedging action is provided by a shallow wedge whereby, in use, the trailing end of the collar is expanded into operative sealing engagement with the barrel.

28. A method according to any one of claims 25 to 27 wherein the trailing collar is mounted for limited axial movement relative to the projectile body and the leading end of the collar formed with an annular sealing face engageable with a complementary face formed on the projectile body whereby rearward movement of the projectile body resulting from the reaction of propellant gases thereon forces the its complementary face into sealing engagement with the annular sealing face at the leading end of the collar.

29. A method according to claim 28 wherein the complementary face and the annular sealing face extend substantially radially and are formed with complementary sealing features thereon and wherein these faces are complementary part-conical sealing faces which wedge into tight sealing engagement with one another.

30. A method according to any one of claims 25 to 29 wherein each projectile is associated with a high pressure propellant chamber which exhausts to respective low pressure propulsion chambers formed between the adjacent projectiles for efficient low muzzle velocity operation and said high pressure propellant chambers are formed integrally with the projectile body or the trailing collar or are provided at the exterior of the barrel to communicate therewith through ports provided through the barrel wall.

31. A method according to any one of claims 25 to 30 wherein the first, second and third clusters of barrel assemblies are combined with conventional projectiles.

32. A method according to any one of claims 25 to 31 wherein the clusters may be mounted for pivotal movement about an axis athwart the aircraft so that beneficial effects may be achieved such as pivoting the clusters so as to maintain the aim toward the target which may be a point or area target.

33. An aircraft comprising at least two clusters of barrel assemblies, wherein at least one cluster in oriented substantially normal to the axis of the aircraft and at least -one other cluster is oriented substantially parallel to the axis of the aircraft and wherein each cluster comprising a plurality of barrel assemblies having a plurality of projectiles axially disposed therein, which projectiles are associated with discrete, sequentially activated propellant charges for propelling the projectiles through the muzzle of the barrel.

34. An aircraft according to claim 33 wherein each projectile includes a trailing collar captively mounted to the projectile body and when stored in the barrel, extends rearwardly to wedge against the nose portion of a trailing projectile body.

35. An aircraft according to claim 34 wherein wedging action is provided by a shallow wedge whereby, in use, the trailing end of the collar is expanded into operative sealing engagement with the barrel.

36. An aircraft according to any one of claims 33 to 35 wherein the trailing collar is mounted for limited axial movement relative to the projectile body and the leading end of the collar formed with an annular sealing face engageable with a complementary face formed on the projectile body whereby rearward movement of the projectile body resulting from the reaction of propellant gases thereon forces the its complementary face into sealing engagement with the annular sealing face at the leading end of the collar.

37. An aircraft according to claim 36 wherein the complementary face and the annular sealing face extend substantially radially and are formed with complementary sealing features thereon and wherein these faces are complementary part-conical sealing faces which wedge into tight sealing engagement with one another.

38. An aircraft according to any one of claims 33 to 37 wherein each projectile is associated with a high pressure propellant chamber which exhausts to respective low pressure propulsion chambers formed between the adjacent projectiles for efficient low muzzle velocity operation and said high pressure propellant chambers are formed integrally with the projectile body or the trailing collar or are provided at the exterior of the barrel to communicate therewith through ports provided through the barrel wall.

39. An aircraft according to any one of claims 33 to 38 wherein the clusters are mounted for pivotal movement about an axis athwart the aircraft to facilitate pivoting the clusters so as to maintain aim toward the target.
